(19) United States
(12) Patent Application Publication
(10) Pub. No.: US 2003/0029092 A1
(43) Pub. Date: Feb. 13, 2003

(54) System for driving and guiding a sliding pane, retractable in a motor vehicle body casing

(76) Inventors: Carlo Bertolini, Feucherolles (FR); Bernard Dron, Puteaux (FR)

Correspondence Address: Leopold Presser, Scully Scott Murphy & Presser, 400 Garden City Plaza, Garden City, NY, 11530, US

(21) Appl. No.: 10/148,291

(22) PCT Filed: Sep. 28, 2001
(86) PCT No.: PCT/FR01/03013

(30) Foreign Application Priority Data
Sep. 29, 2000 (FR) 00/12431

(51) Int. Cl. E05F 11/48

(52) U.S. Cl. 49/352

(57) ABSTRACT

The invention concerns a system, wherein the door casing does not comprise casing slido rails and at least one of the guide members of the sliding pane (3) comprises either a part (4a-4b) of the slide (4) of the pane frame, which is integral with said slide and extends it inside the door casing (2), or a part of said pane fram slide, arranged in its extension, but separate therefrom, said slide part (4a-4b) being mounted in either case in standard fashion on the corresponding edge of the pane.

The present invention relates to a system for driving and guiding a sliding pane retractable into a motor vehicle bodywork casing, particularly a casing of an opening leaf such as a door.

Various types of systems of this kind, known as “window lifters” for short, have already been proposed in the prior art.

Many years ago, use was made for this purpose of devices comprising moving arms mounted pivoting under the influence of a drive member inside the door casing and one end of which was slidably mounted in a slideway arranged at the base of the pane and secured rigidly to it. Associated with this system were members for laterally guiding the panes, known as “casing slides”.

Such devices were, however, soon abandoned because, not only were they expensive, but they were also heavy, rigid and above all too bulky, causing them to occupy most of the space available in the door casing.

To overcome these drawbacks, it was therefore proposed that recourse be had to window lifter systems in which the sliding pane was driven by a driving cable.

For the pane to be able to slide correctly, it is necessary to guide it at two points, and various devices meeting that requirement were thus proposed.

Use was thus made of devices in which the driving cable was fixed to the bottom of the sliding pane, with one point of the pane being guided by a single rail arranged inside the door casing and directed in the direction of motion of the pane, a second guide point however being provided at the top of the pane, generally near the center pillar of the vehicle bodywork.

For esthetic reasons (excessively large rail) and reasons of limited service life, on account of substantial wear, this system was abandoned, especially since the two casing slides essentially designed to guide the lateral edges of the pane had to continue to be used, leading to an excessive overall cost.

The next step, still with a view to using just one single guide rail inside the casing, was to fix a rigid plate to the lower part of the pane and to guide this plate at two points aligned vertically using the rail.

The distance between the two guide points is, however, short, because of the necessarily small dimensions of the plate fixed to the pane, particularly in the direction of travel of this pane, and this leads to forces which reduce the life of the device. Furthermore, like with the previous system, it is generally necessary to use two casing slides.

With a view to eliminating these casing slides, it was therefore proposed that the driving cable be fixed at two spaced-apart points on the sliding pane, in its widthwise direction, and that the two fixing points be guarded [sic] using two distinct guide rails, housed in the door casing and directed in the direction of travel of the pane (see WO 95/01492 A or the corresponding U.S. Pat. No. 5,855,093).

In theory, if the guide rails are close enough to the lateral edges of the panes, it is possible to dispense with the casing slides, thus reducing the weight and cost of the system.

In practice, however, it is possible to space the guide rails apart sufficiently only if the space available in the door casing is sufficient, something which is rarely the case nowadays when lateral speakers of in-car radio equipment in particular occupy a great deal of space in the door casing.

The result of this is that the two guide rails are frequently too close together and that it is therefore necessary to add one or two casing slide portions, something this system was aimed precisely at avoiding.

In addition, in use, problems with corrosion have been encountered and noise has arisen as the pane moves, and the solutions adopted to overcome these drawbacks have made systems of this type heavier, more complicated and, unfortunately, more expensive.

In any case, it is known that when using casing slides, these do not align perfectly with the slides that equip the window surround, and this poses serious problems.

It is starting out from this last observation that the applicant company envisioned remedying the drawbacks encountered earlier in the systems for driving retractable panes by substituting for the rails of the systems of the prior art either parts extending the window surround slides and forming an integral part thereof, or parts of such surround slides arranged in the continuation of those of the surround, but distinct therefrom, the parts usually fixed to the guide rail or rails here being fixed directly to these slide parts.

The subject of the present invention is therefore a system for driving and guiding a sliding pane retractable into a motor vehicle bodywork casing, particularly into a door casing, this system comprising, inside the casing:

an endless cable secured at two points to the sliding pane and able to drive it in its movement;

a motor for driving this cable in one direction or the other;

pulleys for deflecting this cable;

two members for guiding the sliding pane;

this drive system being characterized in that the door casing has no casing slides and in that at least one of the members for guiding the sliding pane comprises either a part of the window surround slide which forms part of this slide and extends it into the door casing, or a part of such a window surround slide, arranged in its continuation, but distinct therefrom, said slide part in each case fitting over the corresponding edge face of the pane in the usual way.

The window surround slide part housed inside the casing is advantageously rigid or locally stiffened.

At least some of the deflection pulleys are advantageously borne by the lugs fixed to the slide part housed inside the casing and serving to secure the assembly.

As a preference, the two members for guiding the sliding pane inside the casing each comprise either a part contiguous with the window surround slide, this part being arranged at the front and rear respectively of the door of the vehicle and continuing the window surround slide into the door casing, or a part of such a window surround slide, but distinct therefrom, and housed in its continuation inside the door casing.

The system according to the invention may also comprise a guide member consisting of a part of the window surround slide, which may or may not be distinct therefrom and is arranged in its continuation inside the door casing, while the second guide member comprises a guide rail of the prior art, offset as far as possible toward the rear or, respectively, toward the front of the vehicle, with respect to the vertical plane through the center of gravity of the sliding pane.

In all these alternative forms, a maximum amount of space is thus left free for the vehicle designers to site the various arrangements located inside the door casing, or penetrating it, such as the radio or radio-cassette speakers, door handle, storage binnacles, safety items, etc.

Aside from this appreciable advantage, the system according to the invention also has the properties inherent in window surround slides, namely excellent guidance and sliding, excellent resistance to wear and to corrosion, and at the same time an absence of noise as the pane moves.

To simplify fitting, one of the fixing lugs secured to the slides or slide parts may advantageously be given an area large enough for the cable drive motor to be secured to it.

It will be noted in this regard that the system according to the invention can be arranged with equal ease on whichever side of the pane (although it is preferably situated on the inward side of the vehicle) and that, as a consequence, it may be envisioned for a fixing lug to be extended diagonally by a part able to replace or act as back-up to the customary door impact beam.

Finally, the upper interior portion of the door casing, that is to say the upper part of the interior panel and the corresponding belt reinforcement, can be fixed to the slide part or parts acting as members for guiding the pane in the door casing using fixing lugs, or even directly, so as to leave a passage for the pre-assembled window lifter assembly when the latter is being fitted. It is thus possible to produce the assembly consisting of the lower fixing lugs, the motor, the cable for driving the pane and the latter in the form of a modular pane assembly, the upper “beam” of the interior casing being fixed securely at a location or even in a housing provided for that purpose in the door casing.

Other advantages and features of the invention will become apparent from the detailed description which will follow of various implementations thereof, which are given by way of nonlimiting examples. In this description, reference will be made to the appended schematic drawings in which:

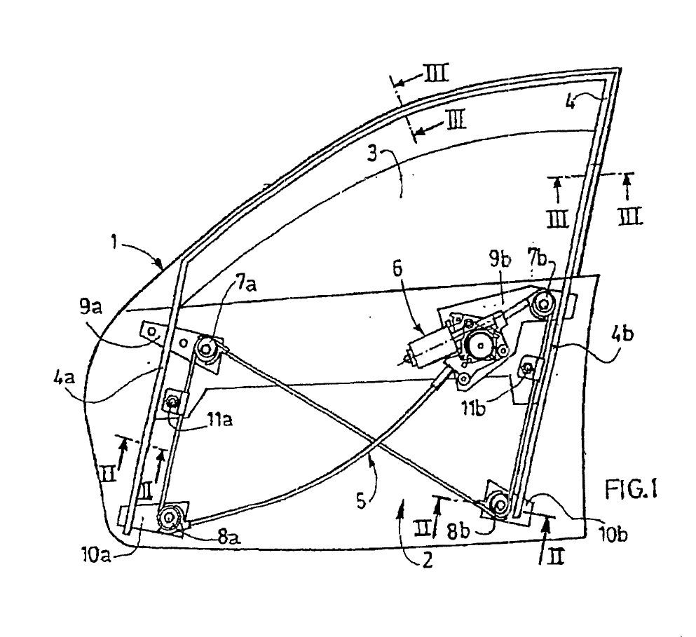

FIG. 1 is a side elevation of the framework of a motor vehicle door equipped with a first version of the system according to the invention, in which version the two guide members consist of continuations into the casing of the window surround slides;

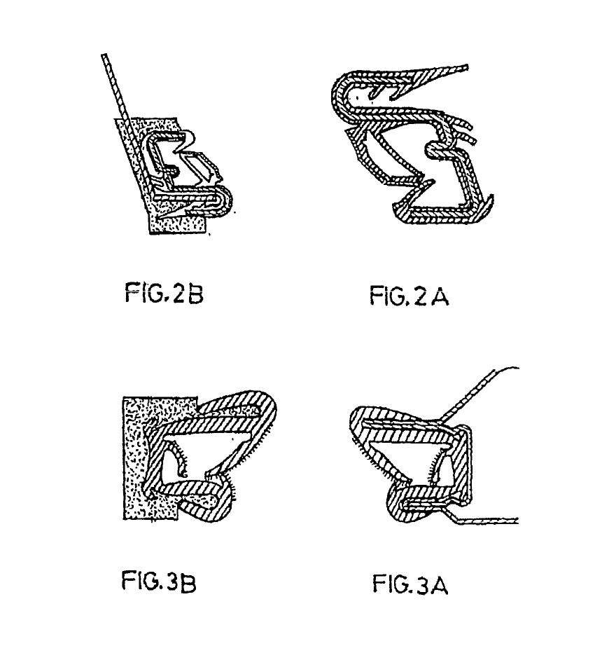

FIGS. 2A and 3A are cross sections on II-II and III-III of FIG. 1, respectively;

FIGS. 2B and 3B are cross sections similar to FIGS. 2A and 3A of another embodiment of FIG. 1;

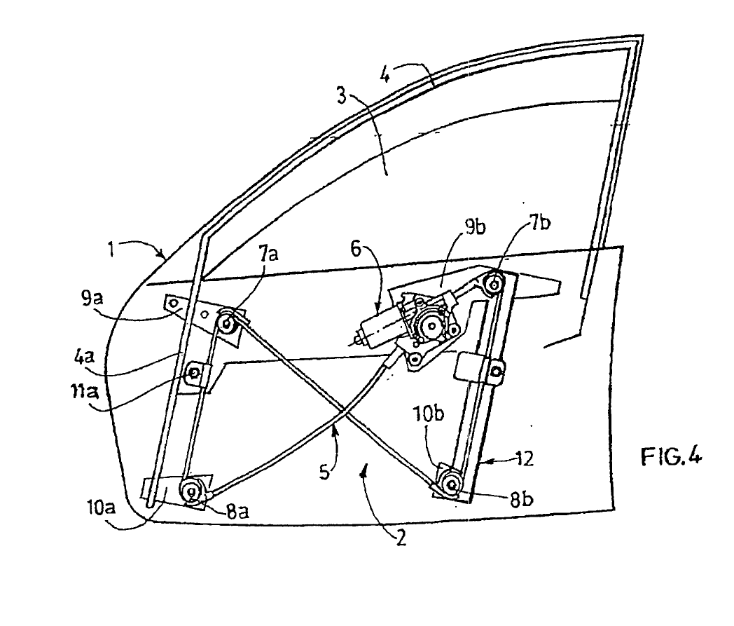

FIG. 4 is a view similar to FIG. 1 of another embodiment of the invention, in which one of the guide members consists of a continuation of the window surround slide at the front of the door casing, and the other guide member is a rail arranged at the rear of the casing, but close to the vertical plane through the center of gravity of the pane;

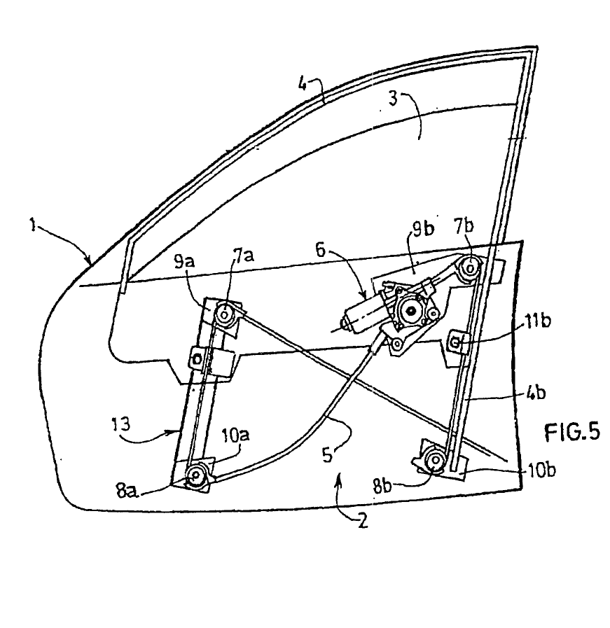

FIG. 5 is a view similar to FIG. 1 of a third embodiment of the invention, in which one of the guide members consists of a continuation of the window surround slide at the rear of the door casing, while the other guide member is a rail arranged at the front of the casing, but close to the vertical plane through the center of gravity of the pane;

FIG. 6 is a view similar to FIG. 1 of a fourth embodiment of the invention, with a more complete sliding pane modular system;

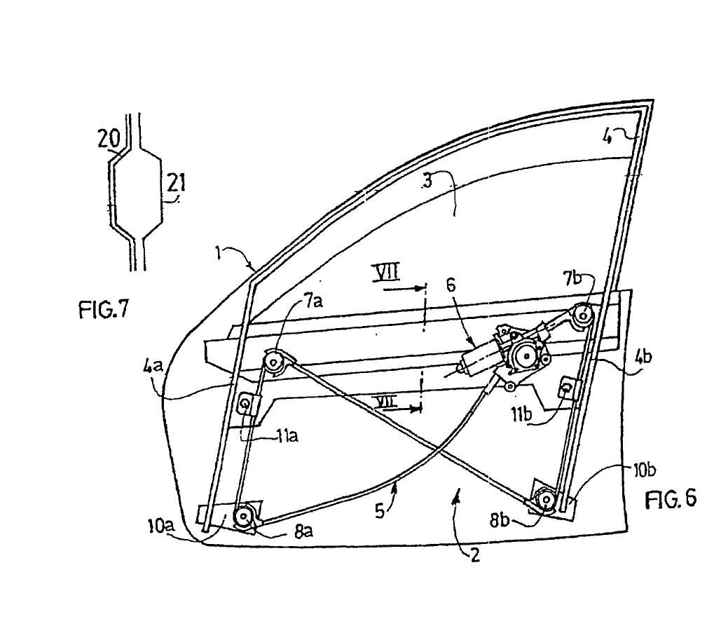

FIG. 7 is a cross section on VII-VII of FIG. 6.

Reference is made first of all to FIG. 1 and to the sections 2A, 2B, 3A and 3B, in which the vehicle door is denoted by the reference 1, the sliding pane retractable into the door casing 2 by the reference 3, and the window surround slide by the reference 4. It is remembered that a section piece for a sliding window surround (known in the art as a “slide”) is made of an elastomeric or thermoplastic material, generally extruded, which is fixed to the window surround and a U-section part of which fits over the periphery of the pane, with a view to guiding it in its movements and sealing this pane when it is in the closed position.

According to the invention, in this embodiment, the window surround slide is continued into the door casing 2 at the front and rear thereof, by parts 4a and 4b respectively, which are integral with them and which here act as the only members that guide the pane inside the door casing.

The pane 3 is influenced by an endless cable 5, with crossing strands, which is driven by a reversible electric motor 6 and which is secured rigidly to the base of the pane at two points 11a and 1b arranged respectively at the front and at the rear of the pane.

The cable 5 passes over four deflection pulleys, two of them, referenced 7a and 7b, being arranged at the upper part of the door casing, at the front and at the rear thereof respectively, while the other two, referenced 8a and 8b, are arranged at the lower part of the casing, at the front and at the rear thereof respectively. These pulleys are borne by fixing lugs, 9a, 9b and 10a, 10b respectively, which are fixed to, respectively, the upper part and the lower part of the parts 4a and 4b of the slides arranged inside the door casing.

These fixing lugs are already used in the customary way in door casings to fix all the distinct elements for guiding and driving the pane, at least one lug being associated with each element, thus making fitting complicated. Here, the number of lugs has been reduced, and this limits the weight of the assembly and the cost of production.

In the embodiment described, one of the lugs, for example the lug 9b, is larger in size than the other fixing lugs and supports the motor 6. Naturally, the other lugs could also have shapes and sizes that allow them to have additional functions within the door casing, as indicated hereinabove.

As the sliding glass is guided in its movements inside the door casing exclusively by the parts 4a and 4b extending the window surround slide 4, without any auxiliary guide member, and particularly without additional casing slides, a maximum volume of space is left free for varied uses within the door casing.

The slide 4 may be of any type known per se and the sections given in FIGS. 2A, 2B, 3A and 3B are intended merely for illustration, without being in any way limiting.

If the slide is itself rigid (FIG. 2A), then the lugs can be fixed locally by injecting a rigid thermoplastic, for example (FIG. 2B).

If the slide is flexible (FIG. 3A) (without a rigid reinforcement), the lugs need to be fixed in the same way but, in addition, it is necessary to at least partially stiffen the region located between the lugs using the same means of injecting rigid thermoplastic (FIG. 3A)

As indicated hereinabove, the parts 4a and 4b are not necessarily contiguous with the window surround slide 4, but may consist of parts distinct from such a slide, arranged in the continuation of the slide 4 in the door casing and directed in the direction of travel of the pane 3.

In the embodiments of FIGS. 4 and 5, in which the members already described are denoted by the same reference numerals, a member for guiding the pane 3 inside the door casing still consists of a part 4a or 4b continuing the window surround slide 4 and arranged, respectively, at the front or at the rear of the door 1, and the deflection pulleys, 7a, 8a and 7b, 8b respectively, are still borne by lugs, 9a, 10a and 9b, 10b respectively, fixed to the respective parts of the slide 4a, 4b. By contrast, a second member for guiding the pane in the casing consists of a guide rail of the type of the prior art, referenced 12 in FIGS. 4 and 13 in FIG. 5.

The rails 12 and 13 are offset as far as possible away from the vertical plane through the center of gravity of the pane 3, toward the rear (FIG. 4) or toward the front (FIG. 5) of the door 1. These guide rails support the fixing lugs 9a, 10a (FIG. 4) and 9b, 10b (FIG. 5).

The free space inside the door casing between the guide members is, in this instance, smaller than the space available in the embodiment of FIG. 1 but, because one of the members for guiding the sliding pane in the door casing still consists of a part 4a, 4b of the window surround slide and because no casing slide is present, the space available is still much larger than the spaces available in the prior art. Furthermore, in these two embodiments, the cost of the system according to the invention proves to be way lower than that of the systems for driving the sliding panes in the prior art, while at the same time offering space at specific locations in the casing.

In FIG. 7, which depicts a preferred implementation of the invention, the members already described are once again denoted by the same reference numerals.

In this embodiment, to make the window lifter assembly according to the invention rigid, use is advantageously made of the door interior belt reinforcement 20 and the bulging part of the door interior panel 21 facing it, and this makes it possible to widen this door border region to make it easier, or simply to make it possible, for the window lifter assembly, delivered entirely pre-assembled, to be introduced and fitted.

It will be noted that, as depicted in FIG. 6, it is possible for the presence of this stiffened region possibly to be put to good use to eliminate the upper fixing lugs supporting the parts 7a and 7b and the motor 6, if the precaution of stiffening the slides 4a and 4b and the beam formed by the volume between the parts 20 and 21 in the way indicated above (by injecting rigid plastic) has been taken. This beam is itself fixed securely at its ends into a location or housing provided for that purpose in the door casing.

1. A system for driving and guiding a sliding pane (3) retractable into a motor vehicle bodywork casing (2), particularly into a door casing, this system comprising, inside the casing:
an endless cable (5) secured at two points to the sliding pane and able to drive it in its movement;
a motor (6) for driving this cable in one direction or the other;
pulleys (7a, 7b, 8a, 8b) for deflecting this cable;
two members for gliding the sliding pane;
this drive system being characterized in that the door casing has no casing slides and in that at least one of the members for guiding the sliding pane (3) comprises either a part (4a-4b) of the window surround slide (4) which forms part of this slide and extends it into the door casing (2), or a part of such a window surround slide, arranged in its continuation, but distinct therefrom, said slide part (4a-4b) in each case fitting over the corresponding edge face of the pane in the usual way.

2. The system as claimed in claim 1, characterized in that the slide part or parts (4a-4b) forming one of the members for guiding the sliding pane (3) are rigid or locally stiffened.

3. The system as claimed in one of claims 1 and 2, characterized in that at least some of the deflection pulleys (7a, 7b, 8c, 8d) are borne by fixing lugs (9a, 9b, 10a, 10b) fixed to the slide part or parts (4a, 4b).

4. The system as claimed in one of claims 1 to 3, characterized in that the motor (6) for driving the cable (5) is borne by a lug 9b fixed to a slide part (4a, 4b) forming a member for guiding the sliding pane.

5. The system as claimed in one of claims 1 to 4, characterized in that the two members for guiding the sliding pane inside the casing each comprise either a part (4a, 4b) contiguous with the window surround slide (4), this part being arranged at the front and rear respectively of the door (3) of the vehicle and continuing the slide (4) into the door casing (2), or a part of such a window surround slide, but distinct therefrom, and housed in its continuation inside the door casing (2).

6. The system as claimed in one of claims 1 to 4, characterized in that it comprises, inside the door casing (2), a guide member consisting of a part (4a, 4b) of the window surround slide (4), which may or may not be distinct therefrom and is arranged in its continuation inside the door casing, while the second guide member comprises a guide rail (12, 13) of a type known per se, offset as far as possible toward the rear or, respectively, toward the front of the vehicle, with respect to the vertical plane through the center of gravity of the sliding pane (3).
